(19) United States
(12) Patent Application Publication
(10) Pub. No.: US 2008/0136848 A1
(43) Pub. Date: Jun. 12, 2008

(54) Display driver including grayscale voltage generator having plural resistors in series each having suitable width

(75) Inventor: Hiroyasu Enjo, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/000,253

(22) Filed: Dec. 11, 2007

(30) Foreign Application Priority Data
Dec. 12, 2006 (JP) 2006-334284

(51) Int. Cl. G09G 5/10

(52) U.S. Cl. 345/690

(57) ABSTRACT

A gradation voltage generation circuit includes a plurality of serially-connected grayscale resistors. The grayscale resistors produce a plurality of gradation voltages. Based on correction information, a width of a selected grayscale resistor is changed without changing a length of the resistor. As a result, the width of the resistor is different from that of a non-selected grayscale resistor.

### BACKGROUND OF THE INVENTION

1. Field of the Invention

The present invention relates to a display driver and a display device for displaying display data.

2. Description of Related Art

Display devices such as TFT (Thin Film Transistor)-type liquid crystal display devices, passive matrix-type liquid crystal display devices, electroluminescence (EL) display devices, and plasma display devices have been widely used. Display data is displayed on the display unit (screen) of the display device.

The display unit is driven by a data driver. The data driver has a gradation voltage generation circuit, which has a resistor strings to generate a plurality of gradation voltage to display the display data.

Display devices are required to adjust much kind of panel products, which have different relationships between electrical input and a light output amount. For example, in a case of a liquid crystal panel, it is known that the property of a relationship between input voltage and panel transmissivity (V-T curve) varies based on the blending way of liquid crystal materials and the electrode configurations. In order for panels having such different optical properties such as a γ curve, the gradation voltages are required to adjust to the panel properties. The adjustment is carried out by the change of the resistance of the resistor, which is an analog quantity. Therefore, such adjustment is delicate and fine.

Japanese Patent Application Laid-open Publication No. 2003-152079 describes a method of designing a reference voltage generating mechanism. It uses a resistor which has an electrically homogeneous in a longitudinal direction and has both ends to which a constant voltage is applied.

This designing method forms a resistor provided between the voltage output units and having a curve portion. The method calculates a compensating rate used for converting the length of a current path in the curve portion calculated by using an actually-measured resistance value of the curve portion into the length of a current path as a straight line portion. The method figures out a resistance value between the voltage output units including the curve portion by using the compensating rate. This makes it possible to downsize a space with a simple configuration and to provide a highly-accurate reference voltage for each grayscale level.

However, this method requires the change of the length of the resistor. The change requires the change of the layout of taps, connected to the resistor, which are used for outputting grayscale voltages. Therefore, the method requires the changes of the masks for the resistor and the taps. It causes the problem of increasing the costs.

### SUMMARY OF THE INVENTION

A gradation voltage generation circuit includes a plurality of serially-connected grayscale resistors. The grayscale resistors produce a plurality of gradation voltages. Based on correction information, a width of a selected grayscale resistor is changed without changing a length of the resistor. As a result, the width of the resistor is different from that of a non-selected grayscale resistor.

In a case of a display device of the present invention, since the length of the selected grayscale resistor is not changed, it is unnecessary to change the position of the tap portion connected to the selected grayscale resistor. In this case, it suffices to change only a mask (resistor forming mask) for forming the multiple grayscale resistors, while it is unnecessary to change masks (tap forming masks) for forming tap contact layers and tap wiring layers of the tap portions. Accordingly, a major change of the mask series is not required, and thereby the costs are only required for the resistor forming mask.

In this way, the display device of the present invention makes it possible to reduce the costs.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 shows a configuration of a TFT-type liquid crystal display device 1 according to an embodiment of present invention;

FIG. 2 shows a configuration of a data driver;

FIG. 3 shows a configuration of a gradation voltage generation circuit;

FIG. 4 shows a configuration of a D/A converter and a data output circuit;

FIG. 5 is a layout diagram of multiple resistors connected in series between terminals V1 and V2 in the gradation voltage generation circuit; and

FIG. 6 is a flowchart showing steps of manufacturing the TFT-type liquid crystal display device.

### DETAILED DESCRIPTION OF THE EXEMPLARY EMBODIMENT

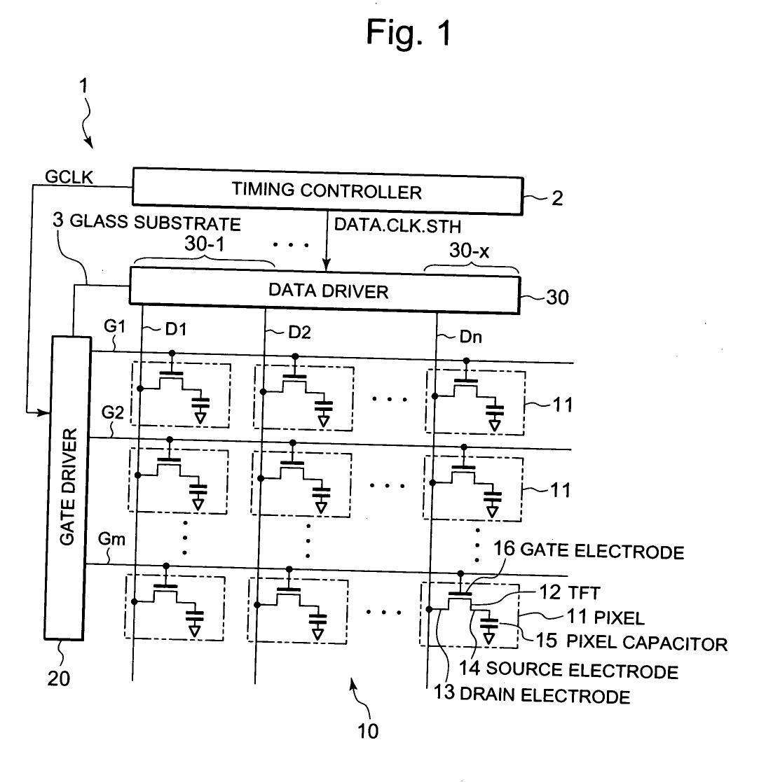

FIG. 1 shows a configuration of a TFT-type liquid crystal display device 1 according to an embodiment of present invention.

The TFT-type liquid crystal display device 1 includes a glass substrate 3 and a display unit (liquid crystal panel) 10.

The liquid crystal panel 10 includes multiple pixels 11 arranged in a matrix on the glass substrate 3. For example, as the multiple pixels 11, (m×n) pixels 11 are arranged on the glass substrate 3 (each of m and n is an integer not less than 2).

Each of the (m×n) pixels 11 includes a thin film transistor (TFT) 12 and a pixel capacitor 15. The pixel capacitor 15 includes a pixel electrode and a counter electrode facing the pixel electrode. The TFT 12 includes a drain electrode 13, a source electrode 14 connected to the pixel electrode, and a gate electrode 16.

The TFT-type liquid crystal display device 1 includes a gate driver 20, a data driver 30, first to m-th gate lines G1 to Gm, and first to n-th data lines D1 to Dn.

The gate driver 20 is provided on a chip (not-illustrated) and is connected to one end of each of the m gate lines G1 to Gm. The data driver 30 is provided on a chip and is connected to one end of each of the n data lines D1 to Dn. The m gate lines G1 to Gm are each connected to the gate electrodes 16 of the TFTs 12 in the pixels 11 in a corresponding one of m lines. The n data lines D1 to Dn are each connected to the drain electrodes 13 of the TFTs 12 in the pixels 11 in a corresponding one of n lines.

The TFT-type liquid crystal display device 1 includes a timing controller 2. For example, in one horizontal time, the timing controller 2 supplies to the gate driver 20 a gate clock signal GCLK for selecting the gate line G1. In response to the gate clock signal GCLK, the gate driver 20 outputs a selection signal to the gate line G1. At this time, the selection signal is transmitted from one end to the other end of the gate line G1 in this order. Then, in response to the selection signal supplied to the gate electrodes 16, the TFTs 12 in the (1×n) pixels 11 corresponding to the gate line G1 are turned on.

The timing controller 2 supplies clock signals CLK and one-line display data DATA to the data driver 30. The one-line display data DATA contains n pieces of display data corresponding to the respective data lines D1 to Dn. The data driver 30 outputs the n pieces of display data to the respective n data lines D1 to Dn, according to the clock signals CLK. At this time, the TFTs 12 in the (1×n) pixels 11 corresponding to the gate line G1 and the n data lines D1 to Dn are in an on state. For this reason, the n pieces of display data are written to the respective pixel capacitors 15 in the (1×n) pixels 11, and are held until the next writing. With this, the n pieces of display data are displayed as the one-line display data DATA.

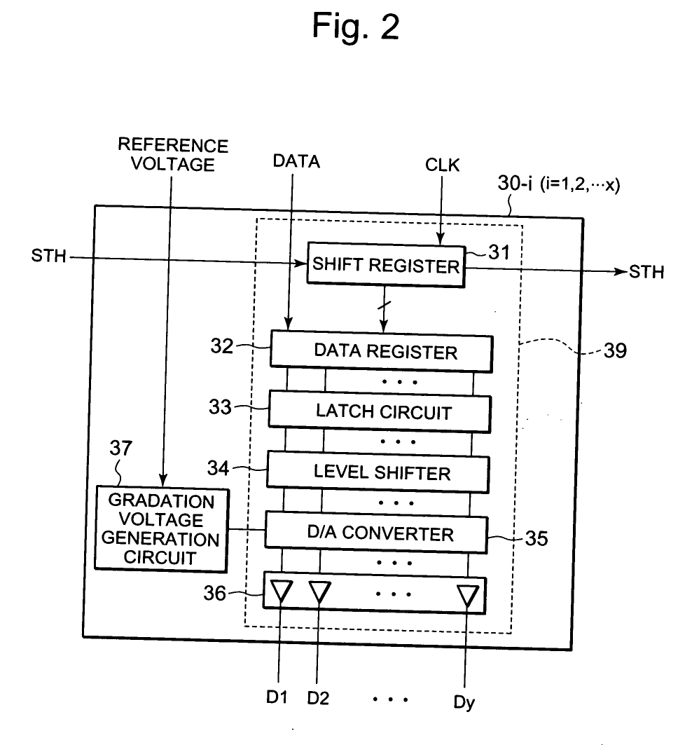

FIG. 2 shows a configuration of the data driver 30. The data driver 30 includes x data drivers 30-1 to 30-x for sharing the display by the n pixels, and the x data drivers 30-1 to 30-x are cascaded (cascade connection) in the order from the first to n-th data drivers in a line direction. Here, x denotes an integer not less than n/y (n>y, y is an integer not less than 2) (note that x is a value obtained by rounding up the solution of n/y if n is not divisible by y).

Each of the x data drivers 30-1 to 30-x includes a shift register 31, a data register 32, a latch circuit 33, a level shifter 34, a digital/analog (D/A) converter 35, a data output circuit 36 and a gradation voltage generation circuit 37.

The shift register 31 is connected to the data register 32, and the data register 32 is connected to the latch circuit 33. The latch circuit 33 is connected to the level shifter 34, and the level shifter 34 is connected to D/A converter 35. The D/A converter 35 is connected to the data output circuit 36 and the gradation voltage generation circuit 37. Each of y output buffers of the data output circuits 36 are connected to one end of a corresponding one of the y data lines D1 to Dy.

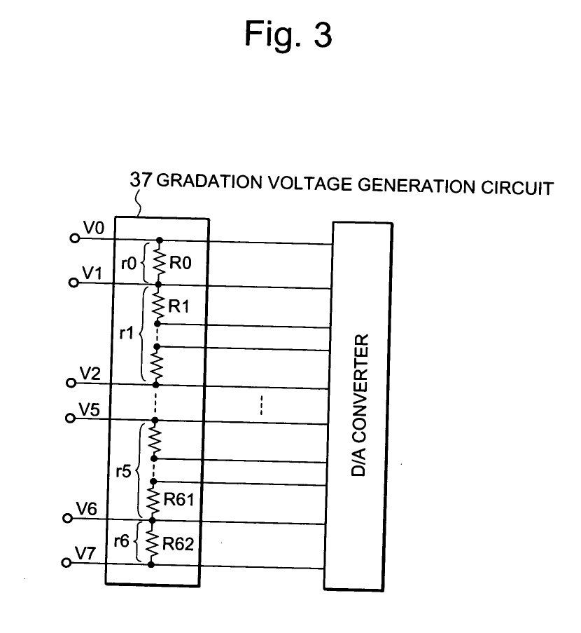

The gradation voltage generation circuit 37 includes multiple grayscale correction resistors connected in series, that is, the resistor string. This gradation voltage generation circuit 37 divides reference voltages from power supply circuits (not-illustrated) by use of the multiple grayscale resistors, and thus generates multiple gradation voltages. For example, when the TFT-type liquid crystal display device 1 makes a display with 64 grayscales, the gradation voltage generation circuit 37 divides reference voltages V0 to V7 by use of 63 grayscale resistors R0 to R62, as shown in FIG. 3, and thereby generates positive gradation voltages of 64 grayscales as the multiple gradation voltages. The same operation is performed for negative gradation voltages.

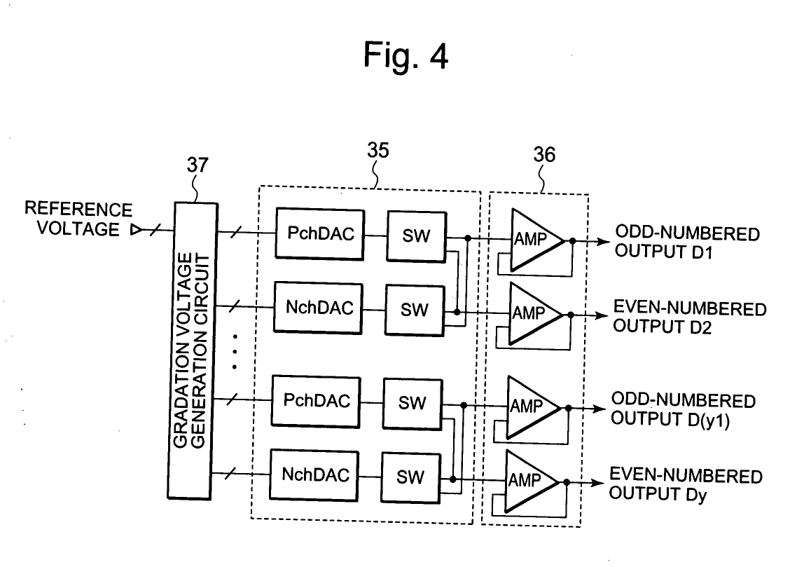

The shift register 31 includes y shift registers (not-illustrated). The data register 32 includes y data registers (not-illustrated). The latch circuit 33 includes y latch circuits (not-illustrated). The level shifter 34 includes y level shifters (not-illustrated). The D/A converter 35 includes y D/A converters (see FIG. 4). The y D/A converters include P-type converters (Pch-DACs), each of which outputs the positive gradation voltage as an output gradation voltage, and N-type converters (Nch-DACs), each of which outputs the negative gradation voltage as an output gradation voltage. For example, among the y D/A converters, the odd-numbered D/A converters are used as a Pch-DAC, while the even-numbered D/A converters are used as an Nch-DAC. The D/A converter 35 includes y switching elements for performing inversion driving of alternately applying the positive gradation voltage and the negative gradation voltage to the pixels 11 (see FIG. 4). The data output circuit 36 includes the y output buffers (see FIG. 4).

Operations of the TFT-type liquid crystal display device 1 will be described.

For example, the timing controller 2 supplies clock signals and one-line display data DATA to the controlling unit 39 in the x data drivers 30-1 to 30-x, and supplies a shift pulse signal STH to the controlling unit 39 in the data driver 30-1. In response to the clock signals CLK and the shift pulse signal STH, the controlling unit 39 in the data driver 30-i outputs y pieces of display data contained in the one-line display data DATA, to the respective y data lines D1 to Dy. Here, i is an integer satisfying 1≦i≦x.

In this case, in the data driver 30-i (i=1, 2, . . . , x−1), the y shift registers of the shift register 31 sequentially shift the shift pulse signal STH in synchronization with the clock signals CLK, and then output the resultant shift pulse signals STH to the respective y data registers. The y-th shift register of the shift register 31 outputs the shift pulse signal STH to the y-th data register of the data register 32, and also to the data driver 30-(i+1) (i=1, 2, . . . , x−1) (cascade outputs). In the data driver 30-x, the y shift registers of the shift register 31 individually and sequentially shift the shift pulse signal STH in synchronization with the clock signals CLK, and then output the resultant shift pulse signals STH to the respective y data registers of the data register 32.

In the data driver 30-i, the y data registers of the data register 32 respectively capture the y pieces of display data from the timing controller 2 in synchronization with the shift pulse signals STH from the y shift registers of the shift register 31, and then output the y pieces of display data to the respective y latch circuits. At the same timings, the y latch circuits respectively latch the y pieces of display data from the y data registers of the data registers 32, and output the y pieces of display data thus latched to the respective y level shifters of the level shifter 34. The y level shifters respectively convert the levels of the y pieces of display data, and then output the resultant y pieces of display data to the respective y D/A converters of the D/A converter 35. The y D/A converters respectively perform digital/analog conversions of the y pieces of display data from the y level shifters of the level shifter 34.

For example, as shown in FIG. 4, among the positive gradation voltages of 64 grayscales, the Pch-DACs of the odd-numbered (1st, 3rd, . . . , (y−1)-th) D/A converters respectively select the output gradation voltages corresponding to the pieces of display data from the odd-numbered (1st, 3rd, . . . , (y−1)-th) level shifters. Then, the Pch-DACs respectively output the selected gradation voltages to the odd-numbered (1st, 3rd, . . . , (y−1)-th) output buffers of the data output circuit 36 via the odd-numbered (1st, 3rd, . . . , (y−1)-th) switching elements. In this case, among the negative gradation voltages of 64 grayscales, the Nch-DACs of the even-numbered (2nd, 4th, . . . , y-th) D/A converters respectively select the output gradation voltages corresponding to the pieces of display data from the even-numbered (2nd, 4th, . . . , y-th) level shifters. Then, the Nch-DACs respectively output the selected gradation voltages to the even-numbered (2nd, 4th, . . . , y-th) output buffers of the data output circuit 36 via the even-numbered (2nd, 4th, . . . , y-th) switching elements.

On the other hand, in a case where the inversion driving is performed, as shown in FIG. 4, the Pch-DACs of the odd-numbered (1st, 3rd, . . . , (y−1)-th) D/A converters respectively select, among the positive gradation voltages of 64 grayscales, the output gradation voltages corresponding to the pieces of display data from the odd-numbered (1st, 3rd, . . . , (y−1)-th) level shifters, and then respectively output the selected gradation voltages to the even-numbered (2nd, 4th, . . . , y-th) output buffers of the data output circuit 36 via the odd-numbered (1st, 3rd, . . . , (y−1)-th) switching elements. In this case, the Nch-DACs of the even-numbered (2nd, 4th, . . . , y-th) D/A converters respectively select, among the negative gradation voltages of 64 grayscales, the output gradation voltages corresponding to the pieces of display data from the even-numbered (2nd, 4th, . . . , y-th) level shifters, and then respectively output the selected gradation voltages to the odd-numbered (1st, 3rd, . . . , (y−1)-th) output buffers of the data output circuit 36 via the even-numbered (2nd, 4th, . . . , y-th) switching elements.

With this operation, the y D/A converters respectively output the y output gradation voltages to the y output buffers of the data output circuit 36. To the y data lines D1 to Dy, the y output buffers output the y pieces of display data from the D/A converter 35, respectively.

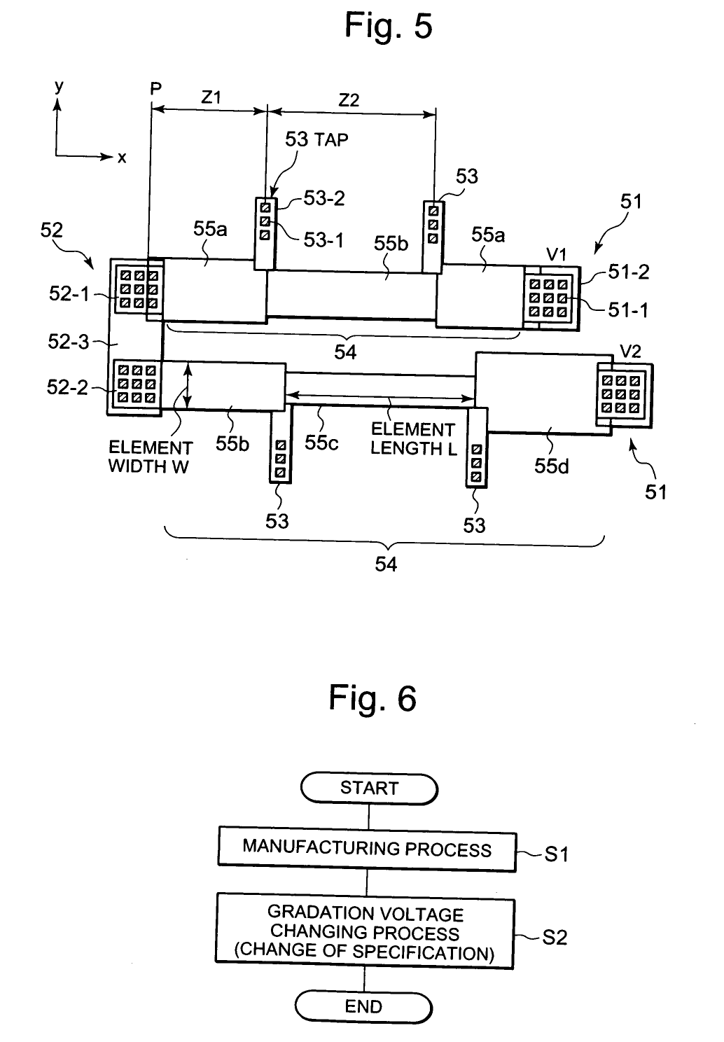

FIG. 5 is a layout diagram of a grayscale resistor r1 of the gradation voltage generation circuit 37. The grayscale resistor 2 to r6 has substantially the same layout as a layout shown in FIG. 5.

The gradation voltage generation circuit 37 includes multiple voltage terminals 51 which are formed on the chip, that is, a semiconductor substrate, in order to connect the resistor r1. The terminals 51 are provided on both ends of the resistors r1 to provide the reference voltages V1 and V2 to the resistor r1.

Each of the voltage terminals 51 includes a voltage terminal contact layer 51-1 and a voltage terminal wiring layer 51-2. The voltage terminal contact layer 51-1 is formed on the chip, and the voltage terminal wiring layer 51-2 is formed on the voltage terminal contact layer 51-1.

The gradation voltage generation circuit 37 includes multiple divided resistors 54 which are formed on the chip, and which are each obtained by dividing the grayscale resistor r1.

The gradation voltage generation circuit 37 includes a junction terminal 52 which is formed on the chip in order to arrange the divided resistors 54 in the same direction (a direction X), and which are each provided on one end of both ends of a corresponding one of the divided resistors 54, the one end not being connected to the voltage terminals 51.

The junction terminal 52 includes junction terminal contact layers 52-1 and 52-2, and a junction terminal wiring layer 52-3. The junction terminal contact layers 52-1 and 52-2 are formed on the chip, and the junction terminal wiring layer 52-2 is formed on the junction terminal contact layers 52-1 and 52-2 in order to connect the junction terminal contact layers 52-1 and 52-2 to each other.

Each of the divided resistors 54 has three grayscale resistors 55. Though FIG. 5 shows that each divided resistors 54 is divided into grayscale resistors 55, at least one of the divided resistors 54 may be divided. Moreover, the divided resistor 54 may have N grayscale resistors 55, (N is integer >=2).

Each of the divided resistors 54 has two tap portions 53. The tap portions 53 are used for drawing two gradation voltages. When the divided resistor 54 has N grayscale resistors 55, N−1 tap portions 53 are provided. Each of the tap portions 53 is provided on one end of both ends of a corresponding one of the grayscale resistor 55. The tap portion 53 is not provided at the end of the grayscale resistor 55 connected to the voltage terminal 51 or the junction terminal 52.

As shown in FIG. 5, each of grayscale resistors 55 has the respective length which is preliminary determined based on a desired V-T curve characteristic.

In order to provide suitable grayscale voltages from the respective tap portions 53, each width W of grayscale resistors 55 are changed or adjusted to output a corrected grayscale voltages. Therefore, those grayscale resistors 55 have several kind of different width W. For example, the resistor 55b has the width narrower than the width of the resistor 55a. The width of the resistor 55c is smaller than that of the resistor 55b. The width of the resistor 55d is larger than that of the resistor 55a. The resistors 55a to 55d are called as grayscale correction resistors.

Each of the tap portions 53 includes a tap contact layer 53-1 and a tap wiring layer 53-2. The tap contract layer 53-1 is formed on the chip, and the tap wiring layer 53-2 is formed on the tap contact layer 53-1. The tap portions 53 are arranged in a direction Y perpendicular to the direction X in which the grayscale resistors 55 are formed. The tap contact layers 53-1 of the tap portions 53 of the upper grayscale resistor 54 are basically arranged at predetermined intervals, though the arrangement is dependent on the respective length of the divided resistor 55. The tap contact layers 53-1 are also arranged at predetermined intervals.

Even if the resistance value of the selected grayscale resistor 55 is changed, the intervals are not changed because the width W of the selected grayscale resistor 55 is changed. Accordingly, it becomes unnecessary to change the masks for forming the tap contact layers 53-1 and the tap wiring layers 53-2 of the tap portions 53.

FIG. 6 is a flowchart showing steps of manufacturing the TFT-type liquid crystal display device 1.

First, the display driver is formed. At this time, a data for grayscale voltage generator including a plurality of resistors connected in series is provided to have a respective predetermined width and length for the resistors. The masks required for making whole the display driver are provided.

When a TFT display is supplied, the specification of the data driver is determined based on the characteristic of the TFT display. In response to the specification, the gradation voltage is changed and the respective width of the grayscale resistors 55 is changed and stored in a memory as a correction data for the grayscale resistor 55. In this case, a gradation voltage changing process is performed (step S2). For example, the grayscale resistors 54 are formed by a single poly-silicon layer.

For example, the 64 gradation voltages are determined according to the resistance values of the 63 grayscale correction resistors 55. In the gradation voltage changing process (step S2), at least one selected grayscale resistor 55 is changed the resistance value based on the change of the gradation voltage. In this case, the width W of the selected grayscale resistor 55 is changed while the length L of the selected grayscale resistor 55 is not changed.

In the case of the TFT-type liquid crystal display device 1 of the present invention, since the length L of the selected grayscale resistor 55 is not changed, it is not necessary to change the position of the tap portion 53 connected to the selected grayscale resistor 55. Therefore, it suffices to change only the mask (resistor forming mask) for forming the grayscale resistors 55 and it is unnecessary to change the masks (tap forming masks) for forming the tap contact layers 53-1, the tap wiring layers 53-2 and the like of the tap portion 53. Accordingly, when the manufacturing process (step S1) is performed for the first time, the costs for mask manufacturing are required for all the formed masks. However, when the gradation voltage changing process (step S2) is performed in order to change the specification, a major change of the mask series is not required, and thereby the costs are only required for the resistor forming mask.

In this way, the TFT-type liquid crystal display device 1 of the present invention makes it possible to reduce the costs with a change of the resistance value of the selected grayscale resistor 55.

The present invention has been described based on the above examples, but the present invention is not limited only to the above examples, and includes various kinds of alterations and modifications that could be achieved by a person skilled in the art within the scope of the invention of each of claims of this application as a matter of course. For example, the display device of the present invention is employed for not only a TFT (Thin Film Transistor)-type liquid crystal display device, but also a passive matrix-type liquid crystal display device, an electroluminescence (EL) display device, a plasma display device and the like.

Further, it is noted that, Applicant's intent is to encompass equivalents of all claim elements, even if amended later during prosecution

What is claimed is:

1. A gradation voltage generation circuit, comprising:
a plurality of serially-connected grayscale resistors comprising at least first and second grayscale resistors, a width of said first grayscale resistor being different from a width of said second grayscale resistor.

2. The circuit as claimed in claim 1, further comprising:
at least one reference voltage terminal connected to an end of said serially-connected grayscale resistors; and
a plurality of tap portions, at least one of said tap portion, being provided to a corresponding one of said serially-connected grayscale resistors.

3. The circuit as claimed in claim 2,
wherein said serially-connected grayscale resistors are arranged to be at least two lines,
wherein said circuit further comprises a junction terminal provided between the two lines.

4. The circuit as claimed in claim 3, wherein said tap portions in a first line of said two lines are arranged at a first interval, and said tap portions in a second line of said two lines are arranged at a second interval.

5. The circuit as claimed in claim 4, wherein said tap portions outwardly extend from said two lines not to exist inside of a region defined by said two lines.

6. A display driver, comprising:
said gradation voltage generation circuit according to claim 5.

7. A display unit, comprising:
said display driver according to claim 6; and
a display panel displaying display data supplied from the display driver.

8. A method of manufacturing a display driver, comprising
changing a width of a selected grayscale resistor among a plurality of resistors connected in series, without changing a length of the selected grayscale resistor, to change the resistance of the selected grayscale resistor, in order to adjust a characteristic of a display panel.

9. The method as claimed in claim 8, further comprising:
connecting taps to said grayscale resistors,
wherein said taps are not changed when the width of said selected grayscale resistor is changed.

10. The method as claimed in claim 9, wherein a mask for a resistor layer constituting said grayscale resistor is changed, and a mask for said taps are not changed when the width of said selected grayscale resistor is changed.

11. The method as claimed in claim 10, wherein said resistors are arranged to have a bent portion, thereby being arranged to become at least two lines.

12. The method as claimed in claim 11, further comprising:
before the changing, preparing a data for a grayscale voltage generator including said plurality of resistors connected in series, each of said resistors having a predetermined width and length, respectively;

13. A semiconductor device comprising:
a plurality of resistors arranged in series on a line extending in a first direction; and
a plurality of tap portions which connect to a corresponding one of said resistors, each of said tap portions being arranged in a second direction different from said first direction, each of said tap portions including a tap contact layer and a tap wiring layer formed on the tap contact layer, said tap contact layers being arranged at predetermined intervals,
wherein a first resistor of said resistors has a width different from a width of a second resistor of said resistors.

14. The semiconductor device as claimed in claim 13,
wherein said resistors are arranged to be at least two lines,
wherein said semiconductor device further comprises a junction terminal provided between the two lines, said junction terminal being arranged to extend in a direction different from said first direction.

15. The semiconductor device as claimed in claim 14, wherein at least one reference voltage terminal is provided to connect to an end of said resistors arranged in series.

16. The circuit as claimed in claim 15, wherein said tap portions in a first line of said two lines are arranged at a first interval, and said tap portions in a second line of said two lines are arranged at a second interval.

17. The circuit as claimed in claim 16, wherein said taps outwardly extend from said two lines not to exist inside of a region defined by said two lines.

18. A data driver comprises a gradation voltage generation circuit including said semiconductor device according to said claim 15.
